(19) United States
(12) Patent Application Publication
(10) Pub. No.: US 2007/0136724 A1
(43) Pub. Date: Jun. 14, 2007

(54) Transferring registers in transitions between computer environments

(76) Inventors: Arun Sharma, Union City, CA (US); Rohit Seth, Santa Clara, CA (US); Asit Mallick, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/301,934

(22) Filed: Dec. 12, 2005

(51) Int. Cl. G06F 9/455

(52) U.S. Cl. 718/1

(57) ABSTRACT

A method and apparatus for transferring registers in transitions between computer environments. An embodiment of a method includes running a first process in a first computer environment and switching to a second process in a second computer environment. The method further provides for transferring a register to the second computer environment. A process for transferring the register is based at least in part on current states of the first computer environment and the second computer environment.

### FIELD

An embodiment of the invention relates to computer environments in general, and more specifically to transfer of registers in transitions between computer environments.

### BACKGROUND

Virtualization technology is generally a technology in which a hardware platform supports a number of different computer environments as separate entities. A single hardware platform can provide support for a variety of different types of virtual computer environments, sharing the computer power provided by the hardware. In one example, IPF (Itanium Processor Family of Intel Corporation) virtualization technology provides a robust infrastructure to support a large number of virtual computer on a single platform. For the purposes of this application, a virtual environment (VE) is a computer environment utilizing virtualization technology.

In a virtual environment, a monitor, such as a VMM (Virtual Machine Monitor) may act as an intermediary between the various virtual environments and the computer hardware. Among other functions, the VMM may handle transitions between different virtual environments.

However, the use of virtualization may result in complications in switching between the various virtual environments. In one example, the transfer of various registers, such as the floating point registers of microprocessors, may cause delays when there is a switch between virtual environments. While certain processes are known for handling switches between processes in a single computer environment, virtualization deals with the added complication of switching between possibly unrelated environments, such as from a process in a first virtual environment to a process in a second virtual environment. Switching between such environments may mean the expenditure of a significant amount of overhead if the process for handling registers in a switch of environments is overly complicated. However, if the handling of registers is not handled properly, then there is a risk of leakage of data from one virtual environment to another. Further, the processes in each virtual environment with regard to data storage and handling may be very different, thereby potentially adding another layer of complexity to the process of switching between virtual environments.

### BRIEF DESCRIPTION OF THE DRAWINGS

Embodiments of the invention may be best understood by referring to the following description and accompanying drawings that are used to illustrate embodiments of the invention. In the drawings:

FIG. 1 illustrates an embodiment of a virtual environment in which an embodiment of the invention may be implemented;

FIG. 2 is an illustration of an algorithm for save/restore floating point operations that is expanded under an embodiment of the invention;

FIG. 3 is an illustration of an algorithm for save/restore floating point operations in a particular environment that is expanded under an embodiment of the invention;

FIG. 4 is an illustration of an algorithm for switching between virtual environments in a system;

FIG. 5 is a flowchart to illustrate the handling of a fault in a virtualized system in an embodiment of the invention; and

FIG. 6 is an illustration of a processor that may be utilized in conjunction with an embodiment of the invention.

### DETAILED DESCRIPTION

A method and apparatus are described for transfer of registers in transitions between computer environments.

In one embodiment of the invention, a system provides efficient transfer of registers in transitions between various computer environments. In one example, a system provides for efficient transfer of floating point registers between virtual environments.

In a system that supports virtual environments, there may be a number of different types of virtual environments that are separate and largely unaware of the operation of the other virtual environments. In such operation, there may be situations in which it is necessary to handle the transfer of registers, such as the floating point registers provided for storing floating point numbers in a processor.

In an embodiment of the invention, a monitoring agent or component, such as a virtual machine monitor (VMM), provides for efficient transfers of registers in connection with transitions between virtual environments. In one example of a virtualized system, a VMM acts as a host, and has control of the one or more processors and other platform hardware for the system. The VMM presents guest software with an abstraction of a virtual processor and allows it to execute directly on a logical processor. Each virtual machine then generally has a guest software environment that supports a stack including the operating system and the application software for the virtual environment. Each virtual machine operates independently of other virtual machines. In an embodiment, the virtual OS's (operating systems) may vary, and may include Microsoft Windows, Unix, DOS, Linux, or other types of operating systems.

In a conventional operation, there may be switching between multiple processes running on an operating system and the saving and restoring of registers in such an environment may be handled. Under an embodiment of the invention, registers are handled in switches that are made between multiple operating systems. In one possible embodiment, lazy save and restore operations are supported for switches between virtual guest environments. A lazy save and restore operation is commonly known as an operation in which a value is only saved and restored as needed. Under an embodiment of the invention, a lazy save and restore process is supported while preventing leakage between virtual environments if the virtual environments access the same registers.

In an embodiment of the invention, a process for transitioning between multiple virtual environments is provided in a virtualized system. In an embodiment, this process keeps track of ownership of registers and current states and uses such knowledge at least in part to determine the state of the registers for inter-environment transitions.

A processor may have multiple different types of registers. In a modem processor, it is common for the processor to include multiple integer registers to hold integer values and multiple floating point registers to hold floating point values. While structures can vary, a floating point number will generally be expressed by a mantissa stored in certain register bits and an exponent stored in certain register bits. However, in most applications, the floating point operations and registers are not actually used. For this reason there is generally no reason to save floating point states, which can thus be ignored for the purpose of switching between processes. If floating point states are not used and thus not modified, then a second process can be given new floating point registers. However, if floating point operations have been used, then there are implications. If there is a transfer or leak of data between processes, there can be serious operational consequences. Therefore, in an embodiment of the invention, if the processes of different guest operations do access the same registers, the processes are controlled to prevent data errors. If registers have not been used, then the second process can be given new floating point registers. If the registers have been used, then the register states are fetched and made visible.

Under an embodiment of the invention, switching processes are provided for switches between virtual environments to increase the efficiency of operations. In one embodiment, the addition of multiple operating systems in a switch is addressed by adding another state to a state machine operation. In one embodiment, a three-state machine is used to address saving and restoring of floating point registers.

In a context switch involving multiple virtual environments, it cannot be assumed that each environment is optimized or whether each environment would support lazy save and restore operations. Processes are provided to ensure that each guest environment has the same view as if the system were not virtual. In an embodiment of the invention, saving and restoring of registers is handled without making any assumptions about the processes of each guest environment or how such environment might handle register issues.

In an embodiment of the invention, computer platform physical hardware in used in the implementation of a modified floating point save and restore operation. The physical hardware may include one or more processors, and the processors may include single or multiple cores. In a virtualized environment, processes for the various environments may be split among processors or cores and storage may be spread among the registers of the processors. Because of the complications inherent in the use of multiple processors, computer processes in switches between environments may be greatly simplified if save and restore operations are limited to circumstances in which they are necessary and avoided in other cases.

While the examples and figures presented herein for purposes of illustration may use the terminology and structure relevant to certain processors and certain processes, embodiments of the invention are not limited to any particular processor, hardware platform, or computer environment.

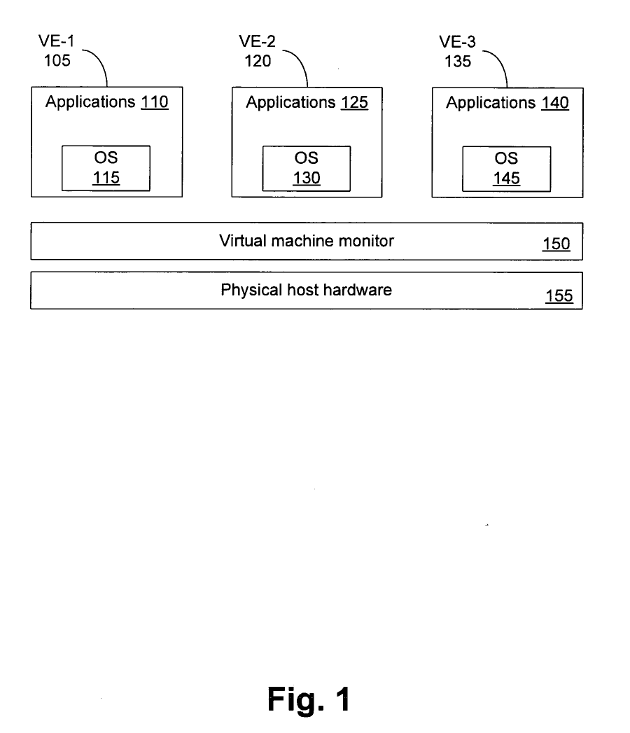

FIG. 1 illustrates an embodiment of a virtual environment in which an embodiment of the invention may be implemented. In this illustration, physical host hardware 155 is available for multiple virtual sessions. The physical host hardware may include multiple processors. A virtual machine monitor 150 is present to provide the environment for the virtual machines. In possible embodiment, there may be a first guest system (virtual environment VE-1 105) comprised of applications 110 and an OS 115, a second guest system (VE-2 120) comprised of applications 125 and an OS 130, and a third guest system (VE-3 135) comprised of applications 140 and an OS 145.

The virtual machine monitor 150 will handle any switches between the guest systems, including dealing with the registers of the processors of the physical host hardware 155. In an embodiment of the invention, the virtual machine monitor 150 will handle registers of the physical host hardware in switches between guest systems using lazy save and restore. In an embodiment, the virtual machine monitor 150 will keep track of ownership of registers to assist the system in detecting when it is necessary to take action with regard to registers.

In an example, a VMM may support a first virtual environment and a second virtual environment. It is assumed that the registers start in a “clean” state (i.e., the register values have not been changed from the values in memory), with the first virtual environment owning certain hardware floating point registers. If a process reads from the registers or takes no action, the registers remain clean and contain the same information as memory. For this reason, the floating point registers can be ignored in a switch to another process or another virtual environment. However, if a process writes to the hardware registers, then the registers are “dirty”, meaning that the contents of such registers are newer than the contents of the memory. For this reason, it is not possible to discard the values in the registers.

In a particular example, floating point registers are handled by a monitoring agent or component, such as a VMM. While floating point registers may vary in format, in one example floating point registers include lower floating point registers f2 through f31, and upper. floating point registers f32 through fl27. In an example, the PSR (processor state register) of an Itanium processor or other similar register maintains the current execution environment. The PSR includes numerous different register fields, including a Dfh (disabled floating point high) field and an Mfh (modified floating point high) field. When PSR.dfh is “1”, then a read or write access to f32 through fl27 (upper floating point registers) results in a disabled floating point register fault. When PSR.mfh is equal to “1”, then this indicates that a value has been written to f32 through fl27. In an embodiment of the invention, the execution environment states reflected by the PSR register fields are used in maintaining the current state of a register.

In a conventional operation, a lazy floating point save and restore algorithm using a typical OS in a non-virtualized environment might be described by Table 1, which represents a state machine for the VMM:

TABLE 1

| State | Dfh | Mfh |
|---|---|---|
| Clean | 0 | 0 |
| Dirty | 0 | 1 |
| Borrowed clean | 1 | 0 |
| Borrowed Dirty | 1 | 1 |

In Table 1, Dfh relates to a disabled floating point high field in the processor status register (PSR.dfh) and Mfh relates to a modified floating point high field in the processor status register (PSR.mfh). The states “clean” and “dirty” specify whether the current high floating point registers are clean (meaning that the data matches with memory) with respect to the state saved in memory, or are dirty (meaning that the data may have changed with respect to the state saved in memory). The terms “borrowed clean” and “borrowed dirty” have similar meanings, but indicate that currently executing process is not the owner of the high floating point registers. If there is a context switch (CSW) out to another process, then the registers are borrowed by a second process. In this example, if a second process accesses the registers, as in a borrowed state, this results in a Dfh (disabled floating point high) fault. This is indicated in Table 1, which indicates that the PSR.dfh field (which may be referred to an exception condition state) is set to “1” (or “true”) when the register is borrowed. Under these circumstances, there is a need to save the first process and then save the second process. Further, if the high floating point registers have been modified (and thus are dirty), this results in the PSR.mfh (which may be referred to as a register contents modification state) being set to “1”. If the registers have not been written to and thus are not dirty, then these registers can be thrown out because the contents of memory reflect the current values of any variables.

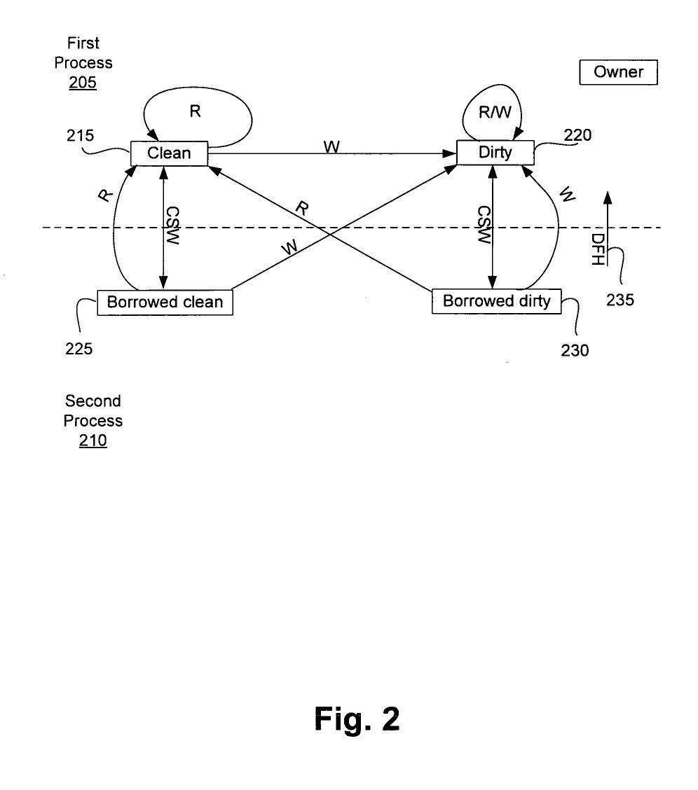

FIG. 2 is an illustration of an algorithm for save/restore floating point operations that is expanded under an embodiment of the invention. In this illustration a first process 205 and a second process 210 of an environment exist and there may be a context switch between the processes. In this illustration, certain registers, such as the floating point registers of a process, may begin in a clean state 215 for the first process, indicating that the memory of the system reflects the current state of the values stored in the registers (PSR.dfh=0 and PSR.mfh=0). If the process reads (“R”) from a register or registers, the registers remain clean. If the registers are clean, then they can be ignored in a switch between processes. However, if the process 205 writes (“W”) to the registers, the registers are dirty 220 and cannot be ignored (PSR.dfh=0 and PSR.mfh=1). Once the registers are dirty, then reading or writing operations will not change the state of the PSR registers.

If there is a context switch to the second process, then the registers are treated as “borrowed”, and thus the state transitions to borrowed clean 225 (PSR.dfh=1 and PSR.mfh=0) or borrowed dirty 230 (PSR.dfh=1 and PSR.mfh=1). In this case, the currently executing process is not the owner of the registers and thus the state is “borrowed”. If the registers are in the borrowed clean state 225, then the registers will be clean 215 if the second process 210 reads from the registers and in a dirty state 220 if the second process 210 writes to the registers. If the state of the registers is borrowed dirty 230, then the registers will be in a dirty state if the second process 210 writes to the registers and in a clean state 215 if the second process 210 reads from the registers. These clean and dirty states are in context of the first process 205. If the second process 210 accesses the data in the registers, this creates a Dfh fault 235 (indicated by the state PSR.dfh=1) that needs to be addressed.

In an embodiment of the invention, the algorithm illustrated is expanded to include transitions between guest environments. In this embodiment, the support for transitions between processes in a computer environment is retained, while transitions between virtual environments are also supported. In an embodiment of the invention, transitions between processes in a single computer environment are unchanged.

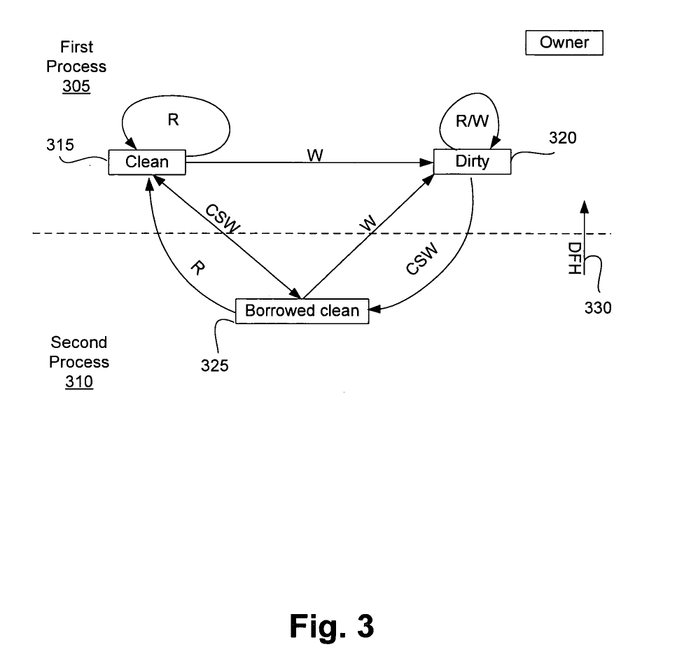

FIG. 3 is an illustration of an algorithm for save/restore floating point operations in a particular environment that is expanded under an embodiment of the invention. FIG. 3 illustrates an algorithm that is applicable to, for example, a multiprocessing (MP) environment. A multiprocessing environment may include a symmetric multiprocessing (SMP) system, a multiprocessor computer architecture in which a multiple physical processors are connected to a single shared main memory. A multiprocessing system may allow any of the multiple processors to be assigned to a task regardless of the location of the data for that task in memory. A multiprocessing system may be designed to move tasks between processors to balance workload. In such a system, the switching between processes can be more complicated because the data in question may be located on differing processors in operation.

In this illustration a first process 305 and a second process 310 of an environment exist and there may be a switch between the processes. In this illustration, certain registers, such as the floating point registers of a processor, may begin in a clean state 315 for the first process, indicating that the memory of the system reflects the current state of the values stored in the registers (PSR.dfh=0 and PSR.mfh=0). If the process reads (“R”) from the registers, the registers remain clean. If the registers are clean, then they can be ignored in a switch between processes. However, if the process 305 writes (“W”) to the registers, the registers are dirty 320 and cannot be ignored (PSR.dfh=1 and PSR.mfh=0). Once the registers are dirty 320, then reading or writing operations will not change the state of the registers.

If there is a context switch to the second process, then the registers are treated as “borrowed”, and thus the state transitions to borrowed clean 325 (PSR.dfh=1 and PSR.mfh=0). In this form of the algorithm, a borrowed dirty state (PSR.dfh=1 and PSR.mfh=1) is not provided because of the difficulty in tracking processes among different processors. In this case, the currently executing process is not the owner of the registers and thus the state is “borrowed”. If the second process accesses the data in the registers, this creates a Dfh fault 330 (indicated by the state PSR.dfh=1) that needs to be addressed.

In a virtualized environment, if there is a switch from one process to another, the floating point registers in question could exist on one of a number of different CPUs. In this case, it would be necessary to use an inter-processor interrupt to address the registers, and information leaks are possible in these circumstances. To address this issue, would be possible to perform a save of every register in case of a switch to another processor. This might be in the form of an eager save, lazy restore process in which saving is done in all cases, but restoring is handled as necessary. However, this process will clearly require a great amount of overhead for the switching process. For example, in many operations, only a small percentage of applications are actually accessing floating point registers, but all registers would be saved in an eager save process. Under an embodiment of the invention, the saving process can be simplified by efficiently keeping track of which processes will require saving. If out of one hundred processes, only one process actually accesses the floating point registers, then it is possible to only store once the system can keep track of which process is the owner of registers. This operation is in the form of a lazy save and restore, and will not result in a fault if a process is not the owner of a floating point register.

In an embodiment of the invention, the saving and restoring of high floating point registers is optimized across the host-guest boundary in a virtualized environment. To maximize performance in a virtualized environment, switching from one virtual environment to another should be efficient with minimal effort for the switch. However, the storing and restoring of floating point numbers can complicate such transfer. If, as in conventional operations, it is necessary to save and restore each floating point register, the result is a significant performance penalty for the virtualized operation.

As indicated above, a physical processor may include a PSR (processor status register) which reflects the current state. Within a guest process in a virtualized environment, there may also be a virtual PSR (VPSR) or similar register or value, which reflects the state that a guest process believes it is accessing. Under an embodiment of the invention, the VPSR may be used in addressing fault conditions in switches between virtual environments.

In an embodiment of the invention, certain assumptions may be made in a particular implementation. First, a guest process may or may not use a lazy floating point algorithm and thus it cannot be assumed how the guest will approach this issue. Second, a VMM is generated or compiled with flags that can prevent use of the f32-fl27 registers. Third, the VMM is modeled as a host OS process. It may also be assumed that most host OS processes and guest OS processes do not generally use the high floating point registers. Because of this, lazily saving and restoring the registers will improve the performance of a system.

In one embodiment of the invention, the operation of an algorithm may reflect Table 2:

TABLE 2

| State | Dfh | Mfh | VM |
|---|---|---|---|
| Clean | 0 | 0 | 0 |
| Dirty | 0 | 1 | 0 |
| Borrowed clean | 1 | 0 | 0 |
| Borrowed Dirty | 1 | 1 | 0 |
| Guest borrowed clean | 1 | 0 | 1 |
| Guest Borrowed Dirty | 1 | 1 | 1 |

In Table 2, there is an additional column VM to identify a virtual process, such as in a field PSR.vm. In this illustration, PSR.vm reflects which virtual or host process is active. PSR.vm being “0” if the host process (the VMM side if the VMM acts as a host process) is active and PSR.vm being “1” if the guest process is active. There are also new states reflecting a guest borrowed clean and a guest borrowed dirty state for processes of the guest environment, for a total of six states. Guest borrowed clean reflects a state in which there has not been any writing to the register (PSR.mfh=0) by the guest process, the registers are borrowed and thus a fault will exist if there is an attempt to access the register (PSR.dfh=1), and the guest process is active (PSR.vm=1). Guest borrowed dirty reflects a state in which there has been writing to the register (PSR.mfh=1), the register is borrowed and thus a fault will exist if there is an attempt to write to the register (PSR.dfh=1), and the guest process is active (PSR.vm=1). The states for clean, dirty, borrowed clean, and borrowed dirty are unchanged from Table 1, with the addition of the indication that the VMM (host) is active (PSR.vm=0).

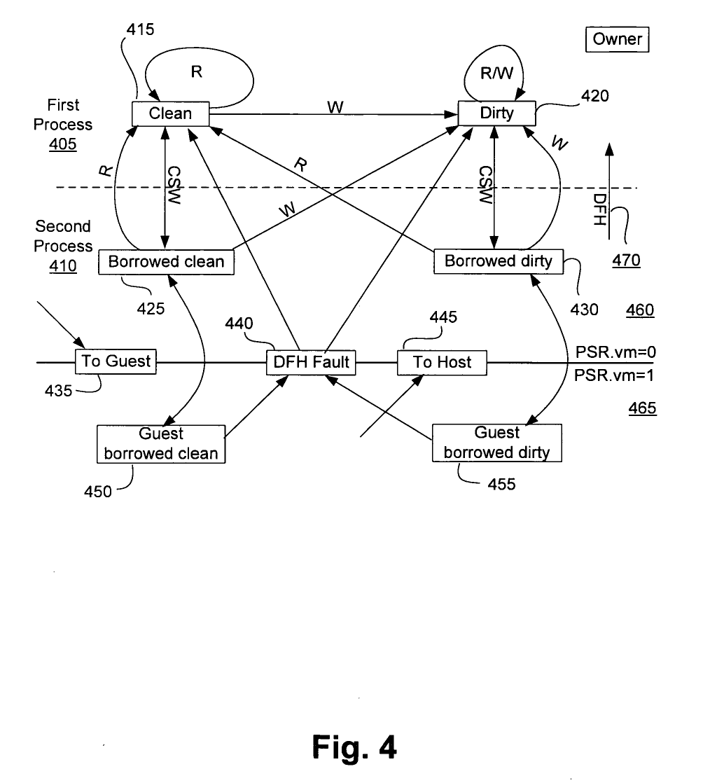

FIG. 4 is an illustration of an algorithm for switching between virtual environments in a system. The illustration is provided from a host perspective and there is no assumption regarding the algorithms of a guest environment, or whether the guest environment would support a lazy save and restore process. In this illustration, there is a division between the host environment (VMM environment) 460, where PSR.vm=0, and a guest environment 465, where PSR.vm=1. Within the host environment 460, there is illustrated a first process 405 and a second process 410. As can be seen from FIG. 4, the system continues to support transitions between processes in an environment, with transitions being made between a clean state 415, a dirty state 420, a borrowed clean state 425, and a borrowed dirty state 430.

However, the algorithm also reflects the transition from a first (host) virtual environment 460 to a second (guest) virtual environment 465. In this operation, there may be a transition from borrowed clean 425 to guest borrowed clean 450, or from borrowed dirty 430 to guest borrowed dirty 455.

In this algorithm, there may be a transition to the guest environment 435, to the host environment 445, or to a Dfh fault condition 440. Each transaction may be addressed by an algorithm that determines a resulting state.

In a first algorithm, the state that will result from a transition to the guest environment 435 may be addressed. In this transition, the Dfh state (or exception condition state) for the guest environment may be determined by setting the PSR.dfh to be the logical OR between the host PSR.dfh and the VPSR.dfh of the guest environment. Stated another way, the resulting processor state for an exception condition is true if it was true for either the host or for the virtual guest process. The Mfh state (or register contents modification state) for the guest environment regarding modification to the upper floating point registers may be determined by setting the PSR.mfh to the state existing for the VPSR of the guest. The algorithm to determine these elements of the state of the guest environment may be expressed as follows:
PSR.dfh=(Host PSR.dfh) OR (VPSR.dfh)
PSR.mfh=VPSR.mfh

In a second algorithm, the state resulting from a transition to the host environment 445 may be addressed. In this algorithm, the exception condition state for a Dfh fault for the host environment will be true if the VMM is not the owner of the register in question, i.e., there is no fault condition if the VMM is the owner of the register. The Mfh state for the host environment regarding modification to the upper floating point registers may again be determined by setting the PSR.mfh to the state existing for the VPSR of the guest. The algorithm may be expressed as:
PSR.dfh=(VMM≠owner)
PSR.mfh=VPSR.mfh

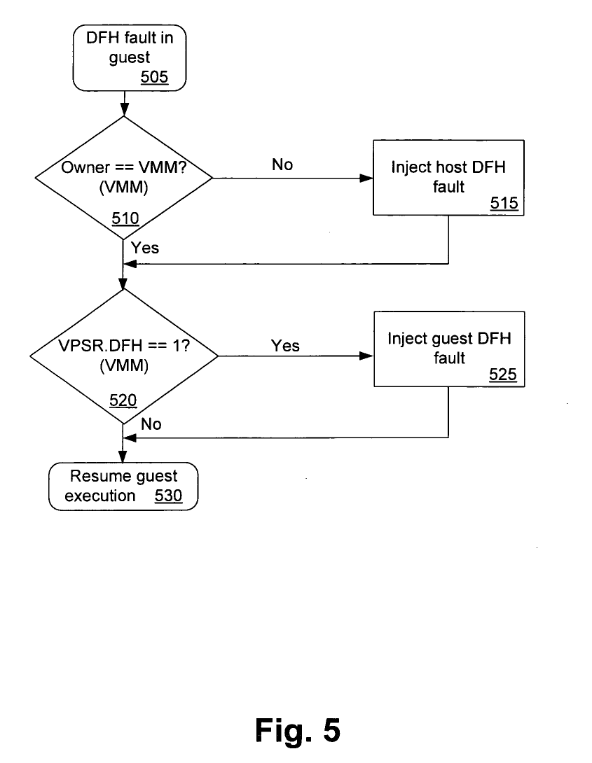

A third algorithm illustrated in FIG. 4 is the Dfh fault 440, an embodiment of which is shown as FIG. 5. FIG. 5 is a flowchart to illustrate the handling of a fault in a virtualized system in an embodiment of the invention. The algorithm may be used to make a determination where a Dfh fault should be injected. In this illustration, if a Dfh fault occurs in the guest environment 505, then there is a determination whether the owner of the registers is the VMM 510. If not, then an issue relates to the host and the system injects a host Dfh fault 515.

There is also a determination whether the virtual PSR state for a Dfh fault is “1”. If so, then the system injects a guest Dfh fault. Following the fault determination, the guest execution can be resumed.

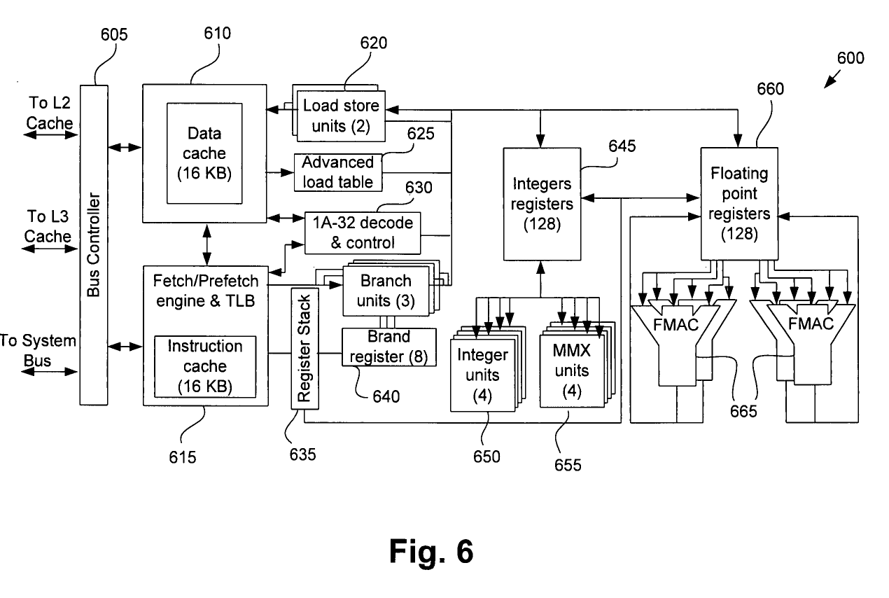

FIG. 6 is an illustration of a processor that may be utilized in conjunction with an embodiment of the invention. The processor 600 may include an Itanium processor family unit of Intel Corporation, and may particularly be used in a virtualized environment that supports multiple guest environments. The processor 600 may be one of multiple processors used in the virtualized environment, and any of the multiple guest environments may utilize the registers and processing power of the processor. While this processor is illustrated, embodiments of the invention are not limited to any particular processor.

The processor 600 may include a bus controller for communications with, for example, caches (L2 and L3 caches shown) and a system bus. The processor 600 may further include a data cache (L1 cache) 610 and fetch/prefetch engine for instructions, including an instruction cache 615. Coupled with the data cache 610 may be load store units 620, and an advanced load table 625. There is also a decode and control unit 630 coupled with the fetch/prefetch engine are branch units and a register stack, which leads to a brand register 640.

The processor then includes arithmetic modules. These modules include integer registers 645 for the storage of integer values, and integer units 650 and MMX (multimedia extension) units 655. The processor further includes floating point registers 660 for the storage of floating point values, as well as FMAC (floating point multiply accumulate) units 665 for floating point calculation. However, many applications do not utilize the floating point registers of a processor and thus a system may provide for a lazy save/restore process in transitions between environments to improve processing efficiency while maintaining data integrity.

In the description above, for the purposes of explanation, numerous specific details are set forth in order to provide a thorough understanding of embodiments of the invention. It will be apparent, however, to one skilled in the art that embodiments of the invention may be practiced without some of these specific details. In other instances, well-known structures and devices are shown in block diagram form.

Embodiments of the invention may include various processes. The processes may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of embodiments of the invention may be provided as a computer program product, which may include a machine-readable medium having stored thereon instructions, which may be used to program a computer (or other electronic devices) to perform a process according to embodiments of the invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, embodiments of the invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of embodiments of the invention. It will be apparent to those skilled in the art that many further modifications and adaptations can be made. The particular embodiments are not provided to limit the invention but to illustrate it. The scope of an embodiment of the invention is not to be determined by the specific examples provided above but only by the claims below.

It should also be appreciated that reference throughout this specification to “one embodiment” or “an embodiment” means that a particular feature may be included in the practice of embodiments of the invention. Similarly, it should be appreciated that in the foregoing description of exemplary embodiments of the invention, various features of embodiments of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
running a first process in a first computer environment;
switching to a second process in a second computer environment; and
transferring a register to the second computer environment, wherein a process for transferring the register is based at least in part on current states of the first computer environment and the second computer environment.

2. The method of claim 1, wherein the register is a floating point register.

3. The method of claim 1, wherein the process for transferring the register comprises a lazy save and restore process.

4. The method of claim 1, wherein the process for transferring the register comprises not saving contents of the register prior to transfer if the first process has not accessed the register.

5. The method of claim 1, wherein the first computer environment comprises a first virtual environment and the second computer environment comprises a second virtual environment.

6. The method of claim 5, wherein the transfer is from a host environment to a guest environment, and wherein an exception condition state of the second computer environment is determined by a logical OR of a host process exception condition state and a virtual process exception condition state.

7. The method of claim 5, wherein the transfer is from a guest environment to a host environment, and wherein an exception condition state of the second computer environment is set to true if a monitoring agent is not the owner of the register.

8. The method of claim 5, further comprising determining a fault condition if the first computer process owns the register and the second computer process accesses the register.

9. The method of claim 8, further comprising injecting a fault to a host process if the host process is the owner of the register.

10. The method of claim 8, further comprising injecting a fault to a guest process if a virtual process exception condition state is true.

11. A monitoring agent comprising:
an interface with a computer platform;
an interface with a plurality of virtual computer environments, the virtual computer environments to include a first virtual environment and a second virtual environment; and
a state machine, wherein the monitoring agent is to handle the transfer of a register between the first virtual environment and the virtual computer environment, the transfer being based at least in part on a current state of the state machine.

12. The monitoring agent of claim 11, wherein the monitoring agent is to act as a host process.

13. The monitoring agent of claim 11, wherein the state machine is to maintain the values of at least three state variables.

14. The monitoring agent of claim 13, wherein one of the state variables for the state machine indicates either that a host process is active or that a guest process is active.

15. The monitoring agent of claim 11, wherein an operating system of the first virtual environment is different than an operating system of the second virtual environment.

16. The monitoring agent of claim 11, wherein the monitoring agent does not save contents of the register if the register has not been used by the first virtual environment.

17. A system comprising:
a computer platform, the computer platform including a processor, the processor including a register;
a dynamic random access memory to hold a plurality of processes to run on the computer platform, the processes to include a first process running in a first virtual environment and a second process running in a second virtual environment; and
a monitoring component, the monitoring component to control the operations of the plurality of processes, the monitoring component to transfer a register from the first virtual environment to the second virtual environment when there is a switch from the first virtual environment to the second virtual environment.

18. The system of claim 17, wherein the register holds a floating point value.

19. The system of claim 17, wherein the monitoring component tracks ownership of the register, and wherein the transfer of the register is based at least in part on the ownership of the register.

20. The system of claim 17, wherein the monitoring component tracks modification of contents of the register, and wherein the transfer of the register is based at least in part on whether the contents of the register have been modified.

21. The system of claim 17, wherein the monitoring component fetches contents of the register and makes such contents visible if the register has been used.

22. The system of claim 17, wherein the monitoring component implements a lazy save and restore process.

23. The system of claim 22, wherein the second virtual environment does not support a lazy save and restore process.

24. A machine-readable medium having stored thereon data representing sequences of instructions that, when executed by a machine, cause the machine to perform operations comprising:
running a first process in a first virtual computer environment;
switching to a second process in a second virtual computer environment; and
transferring a floating point register to the second virtual computer environment, wherein a process for transferring the register is based at least in part on current states of the first virtual computer environment and the second virtual computer environment.

25. The medium of claim 24, wherein the process for transferring the floating point register is a lazy save and restore process.

26. The medium of claim 25, wherein the process for transferring the floating point register comprises not saving contents of the floating point register prior to transfer if the first process did not use the floating point register.

27. The medium of claim 24, further comprising instructions that, when executed by the machine, cause the machine to perform operations comprising:
maintaining a state machine, wherein the state machine includes the current states of the first virtual computer environment and the second virtual computer environment.

28. The medium of claim 27, wherein a state variable for the state machine indicates either that a host process is active or that a guest process is active.
